(19) United States
(12) Patent Application Publication
(10) Pub. No.: US 2019/0232969 A1
(43) Pub. Date: Aug. 1, 2019

(54) DATA COMMUNICATION METHOD FOR A VEHICLE

(71) Applicant: JAGUAR LAND ROVER LIMITED, Coventry (GB)

(72) Inventors: ALEX JUPP, Warwickshire (GB); HARIVADEN PARMAR, Warwickshire (GB); BERNARD STANGL, Warwickshire (GB); CARLOS VINOLO, Warwickshire (GB); MARC BAJET-MENA, Warwickshire (GB)

(21) Appl. No.: 16/260,688

(22) Filed: Jan. 29, 2019

(30) Foreign Application Priority Data
Jan. 30, 2018 (GB) 1801488.6

(51) Int. Cl. B60W 50/02; B60W 50/04; G05B 23/02; H04W 4/48

(52) U.S. Cl. CPC B60W 50/0205; H04W 4/48; G05B 23/0262; B60W 50/04

(57) ABSTRACT

A data communication method for a data communications network within a vehicle, the data communications network comprising a service-oriented architecture, can include initiating a timer at a first controller located within the data communications network upon receipt of a first data message, the first data message comprising a request for a service from a second controller. The method can also include determining if a second data message from the second controller is received at the first controller within a first period of time that is less than or equal to a first predetermined threshold time period. The method can also include outputting a control signal enabling the requested service to be performed based on the first period of time being less than or equal to the first predetermined threshold time period.

### CROSS REFERENCE TO RELATED APPLICATION

This application claims priority to and the benefit of Great Britain Patent Application No. 1801488.6 filed Jan. 30, 2018, which is incorporated herein by reference in its entirety.

### TECHNICAL FIELD

The present disclosure relates to a data communication method for a vehicle and particularly, but not exclusively, to a data communication method for a data communications network within a vehicle having a service-oriented architecture. Aspects of the invention relate to a data communication method for a vehicle, to a controller for a data communications network, to a system comprising the controller for a data communications network, to a vehicle comprising a controller, to a computer program product and to a computer-readable data carrier.

### BACKGROUND

Modern automotive vehicles comprise a large number of embedded controllers, such as electronic control units (ECUs), for controlling a wide range of vehicle functions, such as engine management functions, braking functions, cabin climate functions and steering functions. The ECUs are operatively connected via a vehicle data communications network and may send and receive information via communications channels known as data buses.

FIG. 1 shows an example of a current vehicle data communications network 100 in which multiple ECUs 102, 104, 106 are operatively connected via communications channels 108, 110, 112 known as data buses. A gateway module 114 operatively connects the communications channels 108, 110, 112. ECUs 102, 104, 106 within the data communications network 100 may need to communicate for a wide variety of reasons. For example, sensor data collected by one ECU may be required by another ECU, such as data relating to the speed of the vehicle. In another example, an ECU may not have sufficient processing power to carry out certain calculations and may instead require another ECU to carry out the calculations.

In order to communicate information, ECUs 102, 104, 106 within the data communications network 100 send messages 116 at periodic predetermined time intervals via the data buses 108, 110, 112. The messages are sent via predefined data channels between the ECUs 102, 104, 106. In FIG. 1, a first ECU 102 is shown to receive data messages 116 from a second ECU 104. These data messages 116 are sent by the second ECU 104 at periodic predetermined time intervals of Δt, which in reality may be equal to a time period of around 10 ms. These data channels are predefined at the time of installation of the ECUs 102, 104, 106 within the vehicle. In an example, the first ECU 102 may control the value of speed displayed to the driver via a speedometer within the vehicle cabin. The second ECU 104 may be operatively connected to sensors which determine the current speed of the vehicle and the second ECU 104 may send a message 116 comprising the speed of the vehicle to the first ECU 102 at the predefined time intervals Δt.

Communications of this nature may be described as adopting a sender-receiver model. In the example of FIG. 1, data messages 116 are sent from the first ECU 104 to the second ECU 102, and the first ECU 104 does not receive any confirmation of receipt of the transmitted data messages 116. Instead, each receiving ECU knows the predetermined time interval Δt within which each data message 116 should be received. This may be used as a security feature to detect data communication faults within the vehicle data communications network 100. This is particularly important in safety critical exchanges of data, such as changing from one computing system to another or requests to alter the speed of the vehicle. End-to-end (E2E) protection is an example of a known standardised data communications security protocol, widely adopted within current vehicle data communication networks, which uses the known predetermined timing of transmitted data messages to diagnose communications channel transmission errors. E2E may also be used to verify that messages are received in the correct order and that the data within the messages has not been corrupted. All ECUs 102, 104, 106 within the data communication network 100 may be configured to adopt the E2E protocol.

For illustrative purposes, only one predefined channel for transmitting data messages 116 is shown in FIG. 1. However it is to be appreciated that in actuality, a spectrum of different periodic data messages 116 are sent via a large number of data channels between different vehicle ECUs in order to enable the different functionality associated with the plurality of vehicle ECUs. It is common for existing vehicles to comprise around one hundred different ECUs. Vehicle data communication networks are becoming increasingly more complex as an increasing number of functionalities are catered for by an ever larger arrangement of different vehicle controllers. The current periodic transmission of information adopted within existing vehicle communication networks involves vast amounts of data being sent via the communications network, which may inevitably lead to data bottlenecks, and slower communication. There are additionally difficulties in retrospectively upgrading the vehicle data communications networks with new ECUs, which requires the defining of new data channels between the relevant ECUs upon installation. It is currently extremely complicated and time consuming to define every interaction with every other ECU within the vehicle communications network for a newly installed ECU.

In order to address the above highlighted shortcoming, vehicle manufacturers are beginning to adopt different types of data communications network structure. For example, some vehicle manufacturers are beginning to adopt data communications networks having a service-oriented architecture (SOA), in which data is transmitted between ECUs upon request. This results in a more efficient use of available network bandwidth. Within vehicle data communications network having a SOA, when an ECU requires a service from another ECU, a request for the service is sent. A response is then returned to the requesting ECU. There is therefore no need for data to be continuously sent between ECUs via the existing data channels, as data is only sent when a request for a service is made.

However, the current E2E protocol used to diagnose communication errors, which is currently adopted in vehicle data communications networks cannot be used in a data communications network having a service-oriented architecture.

The present invention has been devised to mitigate or overcome at least some of the above-mentioned problems, and in particular to provide a solution for diagnosing data communication errors in vehicle data communications networks having a service-oriented architecture.

### SUMMARY

According to an aspect of the present invention there is provided a data communication method for a data communications network within a vehicle, the data communications network comprising a service-oriented architecture. The method may comprise initiating a timing means at a first controller located within the data communications network upon receipt of a first data message, the first data message comprising a request for a service from a second controller; determining if a second data message from the second controller, is received at the first controller within a first period of time that is less than or equal to a first predetermined threshold time period and outputting a control signal enabling the requested service to be performed, in dependence on the first period of time being less than or equal to the first predetermined threshold time period. In certain embodiments the timing means may comprise a timer, such as a clock configured to measure an amount of time elapsed between receipt of the first data message and the second data message.

Advantageously, the data communication method provides a way of determining if the data communications network having a service-oriented architecture is functioning correctly. This is achieved by defining a protocol in which for each request for a service, two data messages are sent separated by a first predetermined time interval to a first controller. In dependence on whether the second message is received within the first predetermined threshold time period, the first controller may determine whether there has been a delay in receiving the second data message, and therefore whether there is a communications error within the network. Importantly, this provides a means to diagnose communications errors within a communications network having a service-oriented architecture. This is particularly important when critical services are being transmitted within the vehicle data communications network. A further advantage associated with the present aspect of the invention is that it improves the adoption of vehicle data communications networks having a service-oriented architecture, by providing a means for ensuring that data messages are timely received.

In accordance with certain embodiments, the request for the service comprised in the first data message may comprise a request for an action to be performed, and the method may comprise outputting a control signal comprising instructions for performing the requested action, in dependence on the first period of time being less than or equal to the first predetermined threshold time period.

Advantageously, requested actions may only be performed if it is determined that the request messages were received correctly. It is thereby ensured that safety critical actions, for example switching from a primary computing system to a secondary computing system or altering the braking or speed of the vehicle, are only carried out if it is certain that a correct request was made.

In certain embodiments, the first data message may comprise a request for data. The data may comprise vehicle controller data and/or vehicle sensor data, and the method may comprise outputting a control signal to a relevant vehicle component, the control signal comprising instructions for sending the requested data to the second controller, in dependence on the first period of time being less than or equal to the first predetermined threshold time period.

In certain embodiments, the method may comprise outputting a control signal comprising information indicating that a data communication fault has occurred, in dependence on the first period of time being greater than the first predetermined threshold time period.

In accordance with certain embodiments, the method may comprise determining if a third data message from the second controller, is received at the first controller within a second period of time that is less than or equal to a second predetermined threshold time period; and outputting the control signal enabling the requested service to be performed, in dependence on either the first period of time being less than or equal to the first predetermined threshold time period, or the second period of time being less than or equal to the second predetermined threshold time period.

Advantageously, requiring two out of three request messages to be correctly received enables minor errors in timing within the system to occur without unnecessarily preventing a required service from being provided.

In certain embodiments, the first predetermined threshold time period and the second predetermined threshold time period may be equivalent.

In accordance with certain embodiments, each received data message may comprise information indicative of whether the received data message relates to the second or third data message, and the method may comprise identifying if the received data message relates to the second or third data message from the information indicative of whether the received data message relates to the second or third data message; and determining if the data message is received at the first controller within a time period less than or equal to the first predetermined threshold time period, or the second predetermined threshold time period in dependence on the identified data message.

Advantageously, identifying whether a received data message corresponds to a second or third data message enables the controller to determine whether the data messages have been received in the correct order. This enables the controller to detect errors such as messages being repeated, incorrect messages being inserted into the sequence of messages and incorrect sequences of data messages being received. In dependence on such an error being detected, the controller may take steps to prevent the requested action being performed, thereby providing a further level of safety within the network.

In certain embodiments, the method may comprise sending a response message from the first controller to the second controller upon receipt of each data message. Advantageously, this provides the second controller with confirmation of receipt of the each data message by the first controller.

In certain embodiments, each data message may comprise a verification parameter, generated in dependence on at least a portion of the data message, and the method may comprise outputting the control signal enabling the requested service to be performed, in dependence on the verification parameters of the received data messages being consistent.

In certain embodiments, the verification parameters being consistent may require that the verification parameters correspond in a way that is anticipated based on the methods used to generate each security characteristic. In some embodiments, this may require the verification parameters to be identical.

Advantageously, enabling the requested service to be performed in dependence on the verification parameters within the data messages being consistent enables errors such as the corruption of data messages to be detected. Within the data communications network, information within a message may be lost and it is possible that an incorrect request may be received. In the case of critical applications, it is vital that the requests received are accurate. In an embodiment, the verification parameters may ensure that subsequent messages contain identical requests, thereby ensuring that the request has not been altered.

In accordance with certain embodiments, each verification parameter may be a check value, and the method may comprise performing a cyclic redundancy check of each verification parameter; and determining if the verification parameters are consistent at least partly in dependence on a comparison of the cyclic redundancy check of each verification parameter.

In certain embodiments, the method may comprise outputting a control signal indicating that a data communication fault has occurred, in dependence on the verification parameters of the received data messages being inconsistent.

In accordance with certain embodiments, the verification parameter may be comprised within a header of at least one received data message.

In accordance with a further aspect of the invention there is provided a controller for a data communications network having a service-oriented architecture within a vehicle. The controller may comprise an input configured in use to receive a first data message comprising a request for a service from a second controller and a second data message; timing means (e.g. a timer device) arranged in use to measure a first period of time between receipt of the first data message and receipt of the second data message; a processor configured in use to: determine if the first period of time is less than or equal to a first predetermined threshold time period; and an output configured in use to output a control signal enabling the requested service to be performed, in dependence on the first period of time being less than or equal to the first predetermined threshold time period.

In certain embodiments, the request for the service comprised in the first data message may comprise a request for an action to be performed, and the output may be configured in use to output a control signal comprising instructions for performing the requested action, in dependence on the first period of time being less than or equal to the first predetermined threshold time period.

In accordance with certain embodiments, the first data message may comprise a request for data and the data may comprise vehicle controller data and/or vehicle sensor data. The output may be configured in use to output a control signal to a relevant vehicle component, the control signal comprising instructions for sending the requested data to the second controller, in dependence on the first period of time being less than or equal to the first predetermined threshold time period.

In certain embodiments, the output may be configured in use to output a control signal comprising information indicating that a data communication fault has occurred, in dependence on the first period of time being greater than the first predetermined threshold time period.

In certain embodiments, the processor may be configured in use to determine if a third data message from the second controller is received within a second period of time that is less than or equal to a second predetermined threshold time period; and the output may be configured in use to output the control signal enabling the requested service to be performed, in dependence on either the first period of time being less than or equal to the first predetermined threshold time period, or the second period of time being less than or equal to the second predetermined threshold time period.

In certain embodiments, the first predetermined threshold time period and the second predetermined threshold time period may be equivalent.

In accordance with certain embodiments, each received data message may comprise information indicative of whether the received data message relates to the second or third data message, and the processor may be configured in use to identify if the received data message relates to the second or third data message from the information indicative of whether the received data message relates to the second or third data message; and to determine if the data message is received within a time period less than or equal to the first predetermined threshold time period, or the second predetermined threshold time period in dependence on the identified data message.

In certain embodiments, the output may be configured in use to send a response message to the second controller upon receipt of each data message.

In accordance with certain embodiments, each data message may comprise a verification parameter, generated in dependence on at least a portion of the data message, and the output may be configured in use to output the control signal enabling the requested service to be performed, in dependence on the verification parameters of the received data messages being consistent.

In certain embodiments, each verification parameter may be a check value, and the processor may be configured in use to perform a cyclic redundancy check of each verification parameter; and to determine if the verification parameters are consistent at least partly in dependence on a comparison of the cyclic redundancy check of each verification parameter.

In accordance with certain embodiments, the output may be configured in use to output a control signal indicating that a data communication fault has occurred, in dependence on the verification parameters of the received data messages being inconsistent.

In certain embodiments, the verification parameter may be comprised within a header of at least one received data message.

This aspect of the invention and its embodiments benefit from the same advantages as mentioned in relation to the previous aspect and its embodiments.

In accordance with yet a further aspect of the invention there is provided a system comprising the controller of the preceding aspect of the invention and a second controller, the second controller comprising an input configured in use to receive a first response message from a first controller, the first response message comprising a response to a first request message sent by the second controller; timing means arranged in use to measure a period of time between the first request message being sent and the receipt of the first response message; a processor configured in use to determine if the period of time is less than or equal to a predetermined threshold time period; and an output configured in use to output the first request message; and output a control signal comprising information indicating that a data communication fault has occurred, in dependence on the period of time being greater than the first predetermined threshold time period.

Advantageously, the second controller may verify that the received response messages from the first controller are received when expected. There is thereby provided a further layer of assurance that the data communications network is functioning correctly. Furthermore, the second controller carrying out verification enables the failure of a communications channel to be detected. If a first data message is not received at the first controller, the first controller is not aware that a data message was ever sent. However, if the second controller does not receive a response message within the threshold time period, a failure of the communications channel may be detected.

In accordance with yet a further aspect of the invention there is provided a controller for a data communications network having a service-oriented architecture within a vehicle. The controller comprising: an input configured in use to receive a first response message from a second controller, the first response message comprising a response to a first request message sent by the controller; timing means arranged in use to measure a period of time between the first request message being sent and the receipt of the first response message; a processor; and an output. The processor may be configured in use to: determine if the period of time is less than or equal to a predetermined threshold time period. The output may be configured in use to: output the first request message; and output a control signal comprising information indicating that a data communication fault has occurred, in dependence on the period of time being greater than the first predetermined threshold time period. This aspect of the invention benefits from the same advantages as set out in relation to the preceding aspects of the invention. In particular, this aspect of the invention provides a further layer of assurance that the data communications network is functioning correctly. In accordance with this aspect of the invention, the controller sends a first request message to the second controller and awaits a receipt of a response message from the second controller. If a first request message is not received at the second controller, the second controller is not aware that a data message was ever sent, and therefore cannot determine the integrity of the communication channel. However, if the controller does not receive a response message within the threshold time period, a failure of the communications channel may be detected.

In accordance with yet a further aspect of the invention there is provided a vehicle configured to carry out the method of the previous aspects of the invention, or comprising the controller of the previous aspects of the invention, or comprising the system of the previous aspects of the invention.

In accordance with yet a further aspect of the invention there is provided a computer program product comprising instructions, which when executed on a processor, configure the processor to carry out the method of the preceding aspect of the invention.

In accordance with yet a further aspect of the invention there is provided a computer-readable data carrier having stored thereon instructions for carrying out the method of any of the previous aspects of the invention.

In accordance with yet a further aspect of the invention there is provided a non-transitory computer-readable media having stored thereon instructions for carrying out the method of any of the previous aspects of the invention.

In certain embodiments the instructions may comprise instructions which when executed on a processor configure the processor to: initiate a timer at a first controller located within the data communications network upon receipt of a first data message, the first data message comprising a request for a service from a second controller; determine if a second data message from the second controller, is received at the first controller within a first period of time that is less than or equal to a first predetermined threshold time period and outputting a control signal enabling the requested service to be performed, in dependence on the first period of time being less than or equal to the first predetermined threshold time period.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

FIG. 1, which has already been described in the background section, is a schematic illustration of an example vehicle data communications network known in the state of the art.

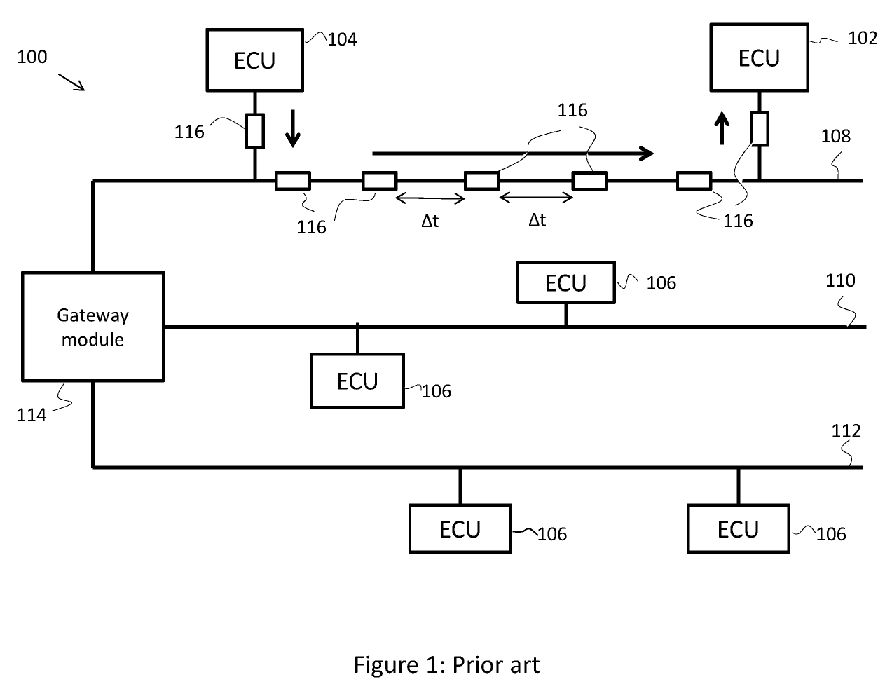

One or more embodiments of the invention will now be described, by way of example only, with reference to the accompanying drawings, in which:

FIG. 2 is a schematic illustration of a data communications network within a vehicle comprising a service-oriented architecture;

FIG. 3 is a schematic illustration of a vehicle controller comprised within the data communications network of FIG. 2;

FIG. 4A is a schematic illustration of the vehicle controller of FIG. 2 receiving data messages from a second vehicle controller comprised within the data communications network of FIG. 1;

FIG. 4B is a schematic illustration of a limited period of communication between the vehicle controller of FIG. 2 and the second vehicle controller;

FIG. 5 is a flow chart outlining the steps carried out by the vehicle controller of FIG. 2 during the limited period of communication; and

FIG. 6 is a schematic diagram of a vehicle comprising the data communications network of FIG. 2.

### DETAILED DESCRIPTION OF THE EMBODIMENTS

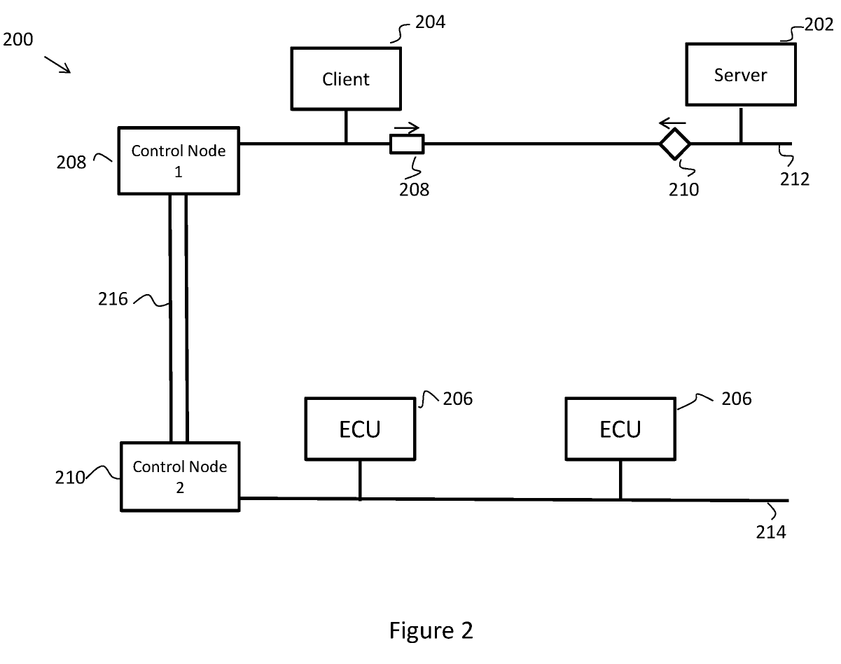

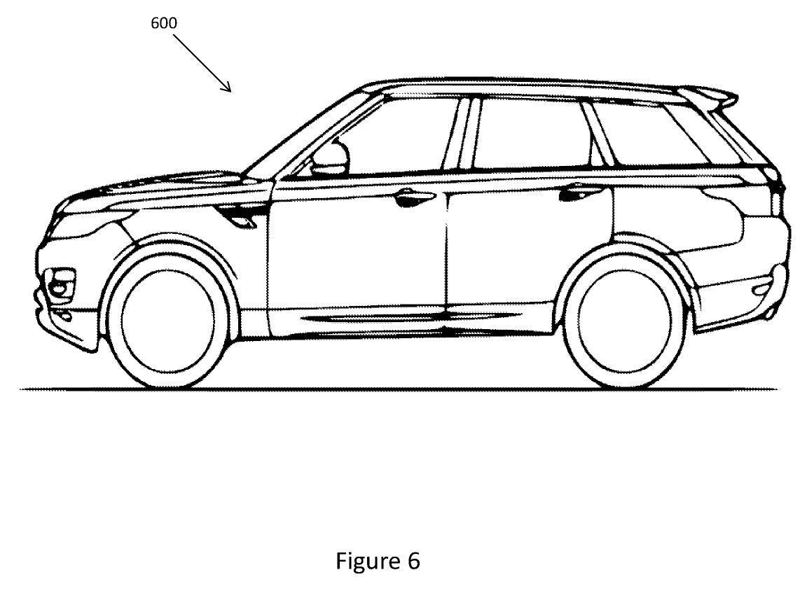

FIG. 2 is a schematic illustration of a data communications network 200 for a vehicle 600 (see FIG. 6) which comprises a service-oriented architecture. For illustrative purposes only, the data communications network 200 is shown to comprise multiple vehicle controllers, which may be referred to as electronic control units (ECUs) 202, 204, 206, a first control node 208 and a second control node 210. The ECUs 202, 204, 206 within the data communications network 200 may be operatively connected via data buses 212, 214. Within the present context, a data bus is a communications channel that operatively connects components within a vehicle in accordance with a bus protocol such as CAN, Flexray or Ethernet. For illustrative purposes only, the automotive communications network 100 is shown to have two data buses 212, 214, but it is to be appreciated that the network 100 may comprise any number of data buses connecting different vehicle components.

Within a service-oriented architecture, services available at a controller 202, 204, 206 may be offered to other controllers 202, 204, 206 within the network 200. As shown within FIG. 2, a first ECU 202 may receive a request for a service from a second ECU 204 via the relevant data bus 212. The first ECU 202 may be referred to as the server 202 and the second ECU may be referred to as the client 204. A request message 208 may be sent via the data bus 206 connecting the ECUs 202, 204. When the server 202 receives the request message 208 from the client 204, the requested service may be carried out by the server 202. A response message 210 may also then be sent via the data bus 212 from the server 202 to the client 204.

The request message 208 may comprise a request for the server 202 to, for example, carry out an action or to provide data to the client 204. The request message 208 may be referred to as a Remote Procedure Call (RPC). In an embodiment, the response message 210 may comprise the requested data or the results of the requested action.

In order to manage the services available at different ECUs 202, 204, 206 and to offer the services to other ECUs 202, 204, 206 operatively connected to different communications channels, the data communications network 200 may comprise a first control node 208 operatively connected to the first data bus 212 and a second control node 210 operatively connected to a second data bus 214. The first control node 212 and the second control node 214 may be connected via a third communications channel 216. In an embodiment, the third communications channel 216 may be a high speed communications channel.

In an embodiment, the first control node 208 and the second control node 210 may receive messages from the ECUs 202, 204, 206 connected to their respective data buses 212, 214 and may determine which services may be offered by each ECU 202, 204, 206. The first control node 208 may send a message to the second control node 210 via the third communications channel 216 offering services available from ECUs 202, 204 operatively connected to the first data bus 212 to ECUs 206 operatively connected to the second data bus 214. The second control node 210 may determine whether the ECUs 206 operatively connected to the second data bus 214 require the advertised services. In this way, when a request for a service 208 is sent from an ECU 202, 204, 206, the control nodes 208, 210 may identify where the service may be available from and then redirect the request 208.

The request 208 sent from the client 204 may be event-based. In other words, the request 208 may be sent by the client 204 upon the determination that a service is required by the client 204. The server 202 is therefore not expecting a message to be received within any certain time period as it is unknown when the event triggering the request 208 may occur. A single request 208 and single response 210 occur as an isolated event with no connection to other request and response communications.

In an embodiment, the client may instead be configured to send a plurality of request messages 208, which may be referred to as a burst of messages, in order to request one service. In an example, the burst of messages may comprise three request messages 208 being sent at equal time intervals. The three request messages 208 may all comprise the same request for a service. In this way a protocol may be set up in which a limited number of requests are sent at set time intervals. The server 202 may be configured to initiate a timer or timer device upon receipt of a first request message 208 and therefore determine whether subsequent request messages 208 comprised within the burst are received within certain periods of time. This will be described in more detail in the ensuing description.

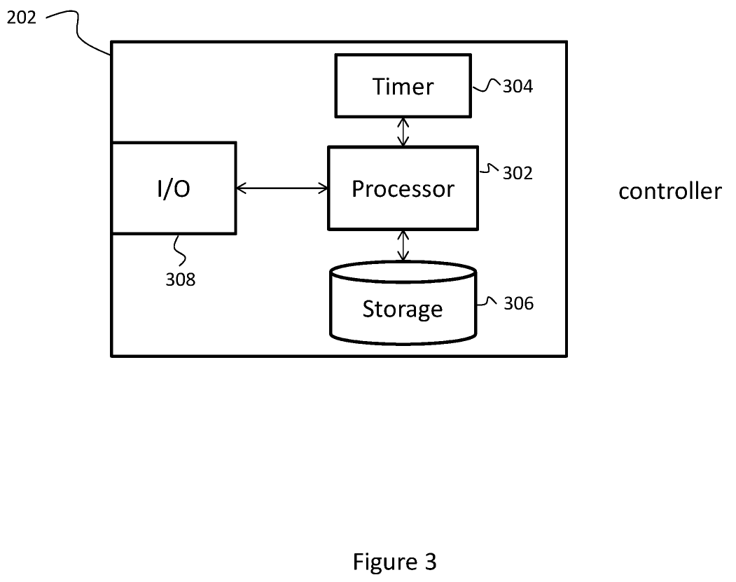

FIG. 3 is a schematic illustration of the first vehicle controller 202 (also referred to as the server 202) comprised within the data communications network 200. The first vehicle controller 202 may comprise a processor 302, timing means such as a timer 304, storage 306 and an input/output (I/O) 308. The input/output 308 may be configured to receive request messages 208 comprising a request for a service from the second vehicle controller 204 (client 204) or any other ECU 206 within the data communications network. In an embodiment, the input/output 308 may be configured to output a response message 210 to the second vehicle controller 204 or other ECU 206 upon receipt of the request message 208.

The timer 304 may be configured to measure the period of time between the receipt of a request 208 and the receipt of a subsequent request 208. The processor 302 may be configured to determine whether a subsequent request 208 has been received at the input/output 308 within a threshold period of time, i.e. that the measured period of time is less than or equal to the threshold period of time. The input/output 308 may be configured to output a control signal enabling the requested service to be performed based on whether at least one subsequent request 208 is received within the threshold time period.

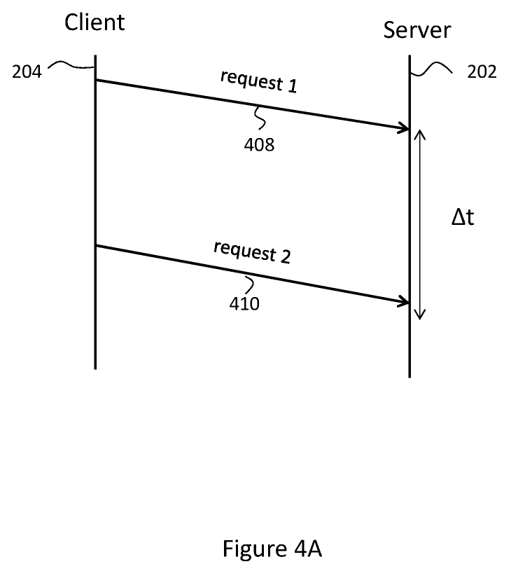

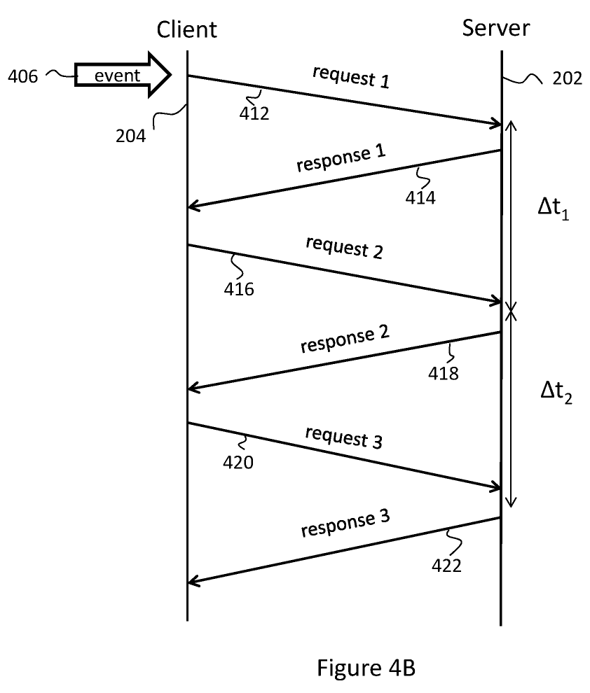

FIG. 4A is a schematic illustration of data communication between the server 202 (first vehicle controller) and the client 204 (second vehicle controller) within the data communications network 200 in an embodiment of the invention.

A first request 408 is sent from the client 204 to the server 202. The first request 408 may be sent upon an event 406 occurring at the client 204. In an example, the event 406 may be the receipt of a control signal from an actuator operatively connected to the client 204.

The first request 408 may be a data message comprising a request for the server 202 to perform an action, for example to perform a calculation or to increase the speed of the vehicle. In an embodiment, the first request 408 may comprise a request for data from the server 202, such as sensor data available to the server 202 or data relating to the server 202.

The first request 408 is received at the server 202 and a timer 304 is initiated at the server 202 upon receipt of this first request 408. The server 202 now may anticipate a further request within a threshold period of time Δt of receiving the first request 408.

A second request 410 is sent from the client 204 to the server 202. In an embodiment, the second request 410 may be sent at a time of Δt after the first request 408 was sent. The second request 410 may comprise a request for an identical service to the first request 408. The second request 410 is received by the server 202 and the server 202 determines whether the second request 410 was received within the threshold time period Δt after the first request 408. Implementing this timeout functionality enables the server 202 to determine if there is a delay in the second request 410 reaching the server 202 or to determine if the second request 410 has been lost.

If the server 202 determines that the second request 410 was received within the threshold time period Δt, the server 202 may then conclude that the data communications network 200 is functioning correctly and may output a control signal enabling the service requested by the client 204 to be performed. For example, the control signal may comprise instructions for an actuator operatively connected to the server 202 to carry out an action or may comprise instructions for the processor 302 to perform a calculation.

However if the server 202 determines that the second request 410 was not received within the threshold time period Δt, the server 202 may determine that an error has occurred within the communications network 200. In an embodiment, the server 202 may output a control signal preventing the requested service from being carried out. The server 202 may also output a signal informing the client 204 that the requested service was not performed.

As described above, in order for the server 202 to determine that the communications network 200 is functioning correctly, a minimum of two request messages 408, 410 are sent by the client 204 to the server 202. However, a greater number of request messages 408, 410 may be sent, as will be illustrated by the example of FIG. 4B.

FIG. 4B is a schematic illustration of the data communication between the server 202 and the client 204 in accordance with an embodiment.

Within FIG. 4B, there is shown to be three requests 412, 416, 420 sent from the client 204 to the server 202. The requests 412, 416, 420 may be sent from the client 204 at predetermined set intervals. As in the case of FIG. 4A, the server 202 initiates a timer 304 upon receipt of the first request 412. The server 202 anticipates receiving the second request 416 within a first predetermined threshold period of time Δt₁. The server 202 then anticipates receiving a third request 420 within a second predetermined threshold period of time Δt₂.

In an embodiment, the first and second predetermined threshold periods of time may be equivalent. The timing may be implemented such that a single timer is initiated upon receiving the first request 412 and such that the server 202 queries whether the subsequent requests 416, 420 have been received at integer multiples of Δt.

By including three messages, the communication protocol may accommodate for what may be determined to be minor errors, such as one of the request messages 412, 416, 420 not being received when anticipated, whilst still determining that the network is functioning adequately for a requested service to be performed. There may be any minimum number of required received request messages 412, 416, 420 within the communication protocol.

In addition, the server 202 sends a response message 414, 418, 422 to the client 204 upon receipt of each request message. This provides the client 204 with the information that each request message has been received at the server 202 and may also enable the client 204 to verify at the client side that the data communications network 200 is functioning as expected. This will be described in more detail in the ensuing description.

FIG. 4B shows a burst of communication between the client 204 and the server 202. There may be any predetermined number of requests sent within the communication sequence, with both the client 204 and the server 202 being aware of this number of request messages. A communication protocol is therefore established which is common to ECUs 202, 204, 206 within the data communication network 200.

In an embodiment, the request messages 412, 416, 420 may comprise further information which may enable the server 202 to determine whether the received request messages 412, 416, 420 include the correct information.

In an embodiment, each request 412, 416, 420 may comprise a verification parameter. The verification parameter may be generated in dependence on at least a portion of information comprised within the respective request message. Upon receipt of the second or third request 416, 420, the processor 302 of the server 202 may determine whether the verification parameters associated with each request 416, 420 are consistent with the verification parameter associated with the first request 412.

The use of a verification parameter may enable the server 402 to determine whether the request messages 412, 416, 420 have been corrupted. For example, some data within the request 412, 416, 420 may have been lost during transmission. The integrity of the request 412, 416, 420 may therefore be verified before the service requested is performed via use of verification parameters.

In an embodiment, the verification parameter may be a check value. The server 202 may perform a Cyclic Redundancy Check (CRC) on the check value to determine the integrity of a received request message 412, 416, 420. The check value may be calculated based on the remainder of a polynomial division of at least a portion of the request message 412, 416, 420. The CRC may comprise determining whether the check values for the received request messages 412, 416, 420 match. If the check values are found to match, it may be determined that the data within the request messages 412, 416, 420 has not been corrupted.

In an embodiment, each request message 412, 416, 420 may comprise information enabling the server 202 to determine whether the request message 412, 416, 420 is a second or third request message 416, 420 of the sequence. In this way the server 202 may be able to detect errors in the communication network involving the repetition of requests 412, 416, 420, insertion of requests 412, 416, 420 or an incorrect sequence of requests 412, 416, 420.

This may be implemented via each request message 412, 416, 420 comprising a sequence counter. Before each message 412, 416, 420 is sent by the client 204, the value associated with the sequence counter may be increased. Upon receiving a request 412, 416, 420, the server 202 may determine whether the value of the sequence counter is as anticipated. As an illustrative example, the first request 412 may have a sequence counter showing a value of 1 and the server 202 may expect the second request 416 to have a sequence counter showing a value of 2.

In an embodiment, the verification parameter and/or the sequence counter may be comprised within a header of the request message 408, 410. The above described checks may be carried out in accordance with an end-to-end (E2E) protection mechanism as is defined within the AUTOSAR protocol.

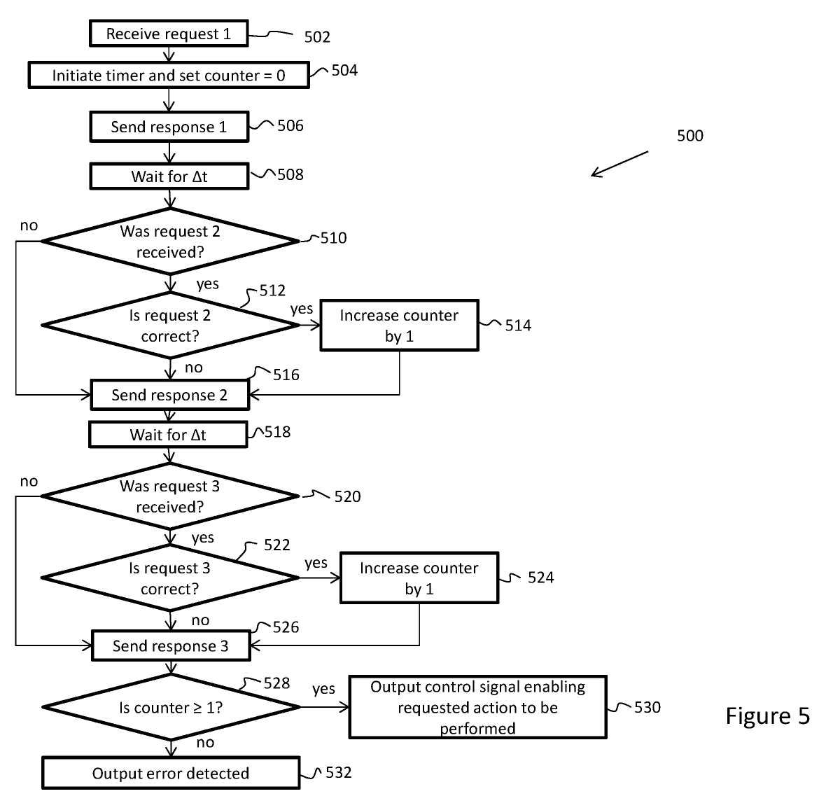

FIG. 5 is a flow chart outlining a method which may be carried out by the server 202 in accordance with the embodiment of FIG. 4B.

At step 502, the server 202 receives a first request 412 and upon receiving this request at step 504, the server 202 initiates a timer 304 and sets an acknowledgement counter equal to zero. As discussed above, the server 202 now anticipates receiving a set number of subsequent requests, each within a predetermined threshold time period. The acknowledgement counter may be used by the server 202 to maintain a record of the number of correct requests received such that this information may be later used to determine whether a requested service should be performed.

The server 202 sends a first response 414 at step 506 and waits for a predetermined threshold time period of Δt₁ from when the first request 412 was received at step 508.

At step 510, the server 202 queries whether a second request 416 was received during the time period Δt₁. If it is determined that a second request 416 was received, the process proceeds to step 512, at which it is queried whether the second request 416 is correct.

As discussed above, the second request 416 being correct may refer to a verification parameter being consistent with the verification parameter associated with the first request 412, the sequence counter showing an anticipated value or performing a comparison with a positive result of any other information associated with the first request 412 and the second request 416.

If the second request 416 is determined to be correct, the server 202 increases the value of the acknowledgement counter by one at step 514. At step 516, the server 202 sends a second response 418 to the client 204.

If at step 510 it is determined that the second request 416 was not received within the threshold time period Δt₁, the server 202 proceeds directly to step 516 and sends the second response 418.

The server 202 waits for a second predetermined threshold time period Δt₂ at step 518 and at step 520 queries whether a third request 420 was received within the second predetermined threshold time period Δt₂. If the third request 420 was received, the process proceeds to step 522, at which it is queried whether the third request 420 is correct. If the third request 420 is correct, the server 202 increases the acknowledgement counter by one at step 524 and sends a third response 422 to the client 204 at step 526.

Similarly to the second request 416, if at step 520 it is determined that the third request 420 was not received within the second predetermined threshold time period Δt₂, the process proceeds directly to step 526 and the server 202 sends the third response 422 to the client 204.

At step 528, it is determined whether the acknowledgement counter has a value greater than or equal to one, meaning that at least one of the second request 416 and the third request 420 were received within the expected time period and were determined to be correct. If the counter value is at least one, the process proceeds to step 530, at which the server 202 outputs a control signal enabling the requested action to be performed.

The server 202 therefore does not perform a requested action until the request for the action has been verified as having been made over a functioning communication network 200.

If instead the counter has a value of less than one, the process proceeds to step 532, at which the server 202 outputs that an error has been detected. In an embodiment, upon the detection of an error, the server 202 may temporarily prevent communication with the client 204. In an embodiment, the server 202 may output a control signal preventing the requested action from being performed.

In an embodiment, verification that the data communications network 200 is functioning correctly may be carried out by the client 204. This may be carried out in addition to the above described method carried out by the server 202. The client 204 may have the same functional components as the server 202, as described in relation to FIG. 3. Namely, the client 204 may comprise a processor 302, a timer 304, storage 306 and an input/output 308.

The client 204 may initiate a timer upon sending the first request 412 and anticipate receiving a first response 414 within a predetermined threshold time period. In this way, the client 204 may detect loss of information within the network. Furthermore the client 204 may detect if access to the communication channel is blocked.

In relation to FIG. 4B, the client may initiate a timing means (such as a timer) upon sending the first request 412. The client 204 may then determine whether the first response 414 is received within a predetermined threshold time Δt₁ of sending the first request 412. After the determination has been carried out, the client 204 may then send a second request 416. In this way, the client functions in a corresponding way to the server 202.

The client 204 may additionally carry out the same verification checks as described above in relation to the server 202, instead basing the verification on whether a correct response 414, 418, 422 is received. The client 204 may therefore also carry out checks involving the consistency of verification parameters and the sequence of received responses 414, 418, 422.

FIG. 6 is a schematic illustration of a vehicle 600, the vehicle 600 comprising the vehicle data communications network 200 including the herein described controller 202.

Many modifications may be made to the above examples without departing from the scope of the present invention as defined in the accompanying claims.

1. A data communication method for a data communications network within a vehicle, the data communications network comprising a service-oriented architecture, the data communication method comprising:
initiating a timing means at a first controller located within the data communications network upon receipt of a first data message, the first data message comprising a request for a service from a second controller;
determining if a second data message from the second controller is received at the first controller within a first period of time that is less than or equal to a first predetermined threshold time period; and
outputting a control signal enabling the requested service to be performed based on the first period of time being less than or equal to the first predetermined threshold time period.

2. The data communication method of claim 1, wherein the request for the service comprised in the first data message comprises a request for an action to be performed, the data communication method further comprising:
outputting a control signal comprising instructions for performing the requested action based on the first period of time being less than or equal to the first predetermined threshold time period.

3. The data communication method of claim 1, wherein the first data message comprises a request for data, the data comprising vehicle controller data and/or vehicle sensor data, the data communication method further comprising:
outputting a control signal to a relevant vehicle component, the control signal comprising instructions for sending the requested data to the second controller, based on the first period of time being less than or equal to the first predetermined threshold time period.

4. The data communication method of claim 1, further comprising:
outputting a control signal comprising information indicating that a data communication fault has occurred based on the first period of time being greater than the first predetermined threshold time period.

5. The data communication method of claim 1, further comprising:
determining if a third data message from the second controller is received at the first controller within a second period of time that is less than or equal to a second predetermined threshold time period; and
outputting the control signal enabling the requested service to be performed based on either the first period of time being less than or equal to the first predetermined threshold time period, or the second period of time being less than or equal to the second predetermined threshold time period; wherein the first predetermined threshold time period and the second predetermined threshold time period are equivalent.

6. The data communication method of claim 1, further comprising sending a response message from the first controller to the second controller upon receipt of each data message.

7. The data communication method of claim 1, wherein each data message comprises a verification parameter generated based on at least a portion of the data message, the data communication method further comprising:
outputting the control signal enabling the requested service to be performed based on the verification parameters of the received data messages being consistent.

8. A controller for a data communications network having a service-oriented architecture within a vehicle, the controller comprising:
an input configured to receive a first data message comprising a request for a service from a second controller and further to receive a second data message;
timing means arranged to measure a first period of time between receipt of the first data message and receipt of the second data message;
a processor configured to determine if the first period of time is less than or equal to a first predetermined threshold time period; and
an output configured to output a control signal enabling the requested service to be performed based on the first period of time being less than or equal to the first predetermined threshold time period.

9. The controller of claim 8, wherein the request for the service in the first data message comprises a request for an action to be performed, and wherein the output is configured to output a control signal comprising instructions for performing the requested action based on the first period of time being less than or equal to the first predetermined threshold time period.

10. The controller of claim 8, wherein the first data message comprises a request for data, the data comprising either or both vehicle controller data and vehicle sensor data, and the wherein the output is configured to output a control signal to a relevant vehicle component, the control signal comprising instructions for sending the requested data to the second controller based on the first period of time being less than or equal to the first predetermined threshold time period.

11. The controller of claim 8, wherein the output is configured to output a control signal comprising information indicating that a data communication fault has occurred based on the first period of time being greater than the first predetermined threshold time period.

12. The controller of claim 8, wherein the processor is further configured to:
determine if a third data message from the second controller is received within a second period of time that is less than or equal to a second predetermined threshold time period;
wherein the output is further configured to output the control signal enabling the requested service to be performed based on either the first period of time being less than or equal to the first predetermined threshold time period or the second period of time being less than or equal to the second predetermined threshold time period.

13. The controller of claim 12, wherein each received data message comprises information indicative of whether the received data message relates to the second or third data message, and wherein the processor is further configured to:
identify if the received data message relates to the second or third data message from the information indicative of whether the received data message relates to the second or third data message; and
determine if the data message is received within a time period less than or equal to the first predetermined threshold time period or the second predetermined threshold time period based on the identified data message.

14. The controller of claim 8, wherein the output is configured in use to send a response message to the second controller upon receipt of each data message.

15. The controller of claim 8, wherein each data message comprises a verification parameter generated based on at least a portion of the data message, and wherein the output is further configured to output the control signal enabling the requested service to be performed based on the verification parameters of the received data messages being consistent.

16. A system comprising the controller of claim 8 and a second controller, the second controller comprising:
an input configured to receive a first response message from a first controller, the first response message comprising a response to a first request message sent by the second controller;
timing means arranged to measure a period of time between the first request message being sent and the receipt of the first response message;
a processor configured to:
determine if the period of time is less than or equal to a predetermined threshold time period; and
an output configured in use to:
output the first request message; and
output a control signal comprising information indicating that a data communication fault has occurred based on the period of time being greater than the first predetermined threshold time period.

17. A vehicle comprising the controller of claim 8.

18. A computer program product comprising instructions which, when executed on a processor, cause the processor to carry out the data communication method of claim 1.

19. A computer-readable data carrier having stored thereon instructions for carrying out the data communication method of claim 1.

20. A non-transitory computer readable media comprising instructions for carrying out the data communication method of claim 1.
